(19) United States
(12) Patent Application Publication
(10) Pub. No.: US 2009/0138850 A1
(43) Pub. Date: May 28, 2009

(54) PROCESSING DEVICE FOR EXTRACTING IMMUTABLE ENTITY OF PROGRAM AND PROCESSING METHOD

(75) Inventor: Yuji YAMAOKA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/273,177

(22) Filed: Nov. 18, 2008

(30) Foreign Application Priority Data
Nov. 22, 2007 (JP) 2007-302377

(51) Int. Cl. G06F 9/44

(52) U.S. Cl. 717/116

(57) ABSTRACT

An unclassified, an immutable entity, a mutable entity, and a neutral entity as kinds of classes are provided. Then all of the classes of a parsed object-oriented program are initially classified as unclassified, and the classifications are changed based on at least a field information and at least parent-child information. Any class that remains unclassified after the classification changes is changed to an immutable entity. Information is output about the classes classified as the immutable entity as immutable entity extraction information.

### CROSS-REFERENCE TO RELATED APPLICATIONS

This application is related to and claims priority to Japanese patent application no. 2007-302377 filed on Nov. 22, 2007 in the Japan Patent Office, and incorporated by reference herein.

### BACKGROUND

1. Field

The present invention relates to immutable object extraction processing in static analysis processing of an object-oriented program, and more particularly to a technique for extracting an immutable object from an object-oriented program in which class structure is statically defined, without executing the program.

2. Description of the Related Art

The immutable object as used herein is a runtime data structure in an object-oriented program in which a tree structure and a value of the object cannot be changed after the object is generated.

An immutable object is often prepared on purpose in a program by a program developer. Setting of an immutable object is made by, for example, defining an immutable class by which all objects of the class's type become immutable objects.

For example, in JAVA, in order to set an immutable object, the following conditions needs to be satisfied in class definition.

A method which may change a field is not prepared;

All fields are made final;

All methods or a class itself is declared final so that override is forbidden; and

When an object whose field is not immutable is referenced, the reference to object is not exposed.

It is well known that when a program developer defines an immutable class properly, there are the following merits, thus improving program productivity.

Specifically, since there is no danger of changing a value in an immutable object, a reference to the immutable object can be freely cached on the premise that the reference always refers to the same value from then on. Further, since a property of the immutable object is not changed as well, a field and a method's result of the immutable object can be freely cached.

Further, if the immutable object is created properly, that is, if it is created such that the object reference is not passed outside of a constructor, the state of the object is not changed, so that conflicts such as of “write-write” and “read-write” are prevented, and therefore it is not required to synchronize access.

Also when an object is passed to an ordinary method, there is no danger that the object is changed and returned back if it is an immutable object.

In view of improving program productivity using an immutable object, a technique for automatically extracting an immutable object is important. Thus, a technique for extracting an immutable object from a JAVA program has been conceived. In this technique, all classes are classified into mutable and immutable classes. Then, a class in which all instance fields are immutable is classified as the immutable class, a class in which there is at least one mutable instance field is classified as the mutable class, and an unclassified class is classified as the mutable class.

The above described technique has problems that processing speed performance is not good and a set of classes having a circular reference structure cannot be extracted or classified. A set of classes having a circular reference structure is a set of classes which refer information required for definition of the classes to each other or circularly. This is one example of a class which cannot be extracted by the conventional method even though it is actually an immutable class.

### SUMMARY

According to an aspect of the invention, a method including a computer readable recording medium and a processing device thereof, for extracting an immutable entity of a program (software) is provided. The processing device comprises a program input unit which accepts as input an object-oriented program to be processed, a class information acquiring unit which parses the inputted object-oriented program, and acquires parent-child information between classes and field information with respect to all classes of the object-oriented program, an initial classification unit which provides an unclassified, an immutable entity, a mutable entity, and a neutral entity as kinds of classes, and classifies all of the classes of the parsed object-oriented program as the unclassified, a first classification changing unit which determines whether or not the class classified as the unclassified has a mutable field based on the field information, and, if the class classified as the unclassified has the mutable field, changes a kind of the class to the mutable entity, a second classification changing unit which identifies a class whose kind is unclassified and which is an ancestor of the class whose kind is classified as the mutable entity, based on the parent-child information, and changes a kind of the identified class to the neutral entity, a third classification changing unit which changes a kind of a descendant class of the class whose kind is classified as the mutable entity to the mutable entity, based on the parent-child information, a fourth classification changing unit which identifies a class whose kind is unclassified and which is an ancestor of the class whose kind is classified as the neutral entity, based on the parent-child information, and changes a kind of the identified class to the neutral entity, an immutable entity extraction unit which extracts a class classified as the unclassified from all the classes after some executions of the first classification change processing, the second classification change processing, the third classification change processing, and the fourth classification change processing, and changes a kind of the extracted class to the immutable entity, and an immutable entity information output unit which outputs information about the class classified as the immutable entity as immutable entity extraction information.

Additional aspects and advantages of the embodiments will be set forth in part in the description which follows, and in part will be obvious from the description, or may be learned by practice of the invention. The aspects and advantages of the invention will be realized and attained by the described elements, operations and combinations particularly pointed out in the appended claims.

It is to be understood that both the foregoing general description and the following detailed description are exemplary and explanatory only and are not restrictive of the invention, as claimed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram of a configuration example of an immutable entity extraction device;

FIG. 2 is a flowchart of processing of the immutable entity extraction device;

FIG. 3 is a flowchart of immutable entity extraction processing;

FIG. 4A is a diagram showing a pseudo code example (1) which implements an immutable entity extraction unit;

FIG. 4B is a diagram showing the pseudo code example (2) which implements the immutable entity extraction unit;

FIG. 4C is a diagram showing the pseudo code example (3) which implements the immutable entity extraction unit; and

FIG. 5 is a diagram showing a code example of a kind of class, a class name, and invalid immutable entity designation which are used by the immutable entity extraction unit.

### DETAILED DESCRIPTION OF THE PREFERRED EMBODIMENTS

In the present embodiment, there are provided three kinds of classes: an immutable entity, a mutable entity, and a neutral entity. Further, as the conditions for classification into an immutable entity, the following conditions are set.

Immutable entity condition 1: assignment is forbidden in all fields of a class, and a type of all the fields is the immutable entity class.

Immutable entity condition 2: all ancestor classes of a class are classified as an immutable entity or a neutral entity.

Immutable entity condition 3: all descendant classes of a class are classified as an immutable entity.

The conditions for classification into a neutral entity are the immutable entity condition 1 and immutable entity condition 2.

From all of classes of a target program, a class which does not satisfy the immutable entity conditions 1 to 3 is recorded using parent-child information and field information of analysis processing result, and a class which remains as an initial class, namely unclassified, is extracted as a class classified as an immutable entity.

A program according to the present embodiment as stored on a computer readable recording medium is intended to cause a computer to execute: 1) program input processing for accepting as input an object-oriented program to be processed; 2) class information acquisition processing for parsing the inputted object-oriented program, and acquiring parent-child information between classes and field information with respect to all classes of the object-oriented program; 3) initial classification processing for providing (defining/specifying) an unclassified, an immutable entity, a mutable entity, and a neutral entity as kinds of classes, and classifying all of the classes of the parsed object-oriented program as the unclassified; 4) first classification change processing for determining whether or not the class classified as the unclassified has a mutable field based on the field information, and, if the class classified as the unclassified has the mutable field, changing a kind of the relevant class to the mutable entity; 5) second classification change processing for identifying a class whose kind is unclassified and which is an ancestor of the class whose kind is classified as the mutable entity, based on the parent-child information, and changing a kind of the identified class to the neutral entity; third classification change processing for changing a kind of a descendant class of the class whose kind is classified as the mutable entity to the mutable entity, based on the parent-child information; 6) fourth classification change processing for identifying a class whose kind is unclassified and which is an ancestor of the class whose kind is classified as the neutral entity, based on the parent-child information, and changing a kind of the identified class to the neutral entity; 7) immutable entity extraction processing for extracting a remaining class classified to be unclassified from all the classes after some executions of the first classification change processing, the second classification change processing, the third classification change processing, and the fourth classification change processing, and changing a kind of the extracted class to the immutable entity; and 8) immutable entity information output processing for outputting information about the classes of the object-oriented program classified as the immutable entity as immutable entity extraction information.

The apparatus including a computer operates as follows.

First, the apparatus accepts as input an object-oriented program to be processed, parses the inputted object-oriented program, and acquires parent-child information between classes and field information with respect to all classes of the object-oriented program. Then, it provides (defines or specifies or sets) an unclassified, an immutable entity, a mutable entity, and a neutral entity as kinds of classes, and classifies all of the classes of the parsed object-oriented program as the unclassified.

Then, it determines whether or not the class classified as the unclassified has a mutable field based on the field information, and, if the class classified as the unclassified has the mutable field, changes a kind of the class to the mutable entity. Further, it identifies a class whose kind is not the mutable entity and which is an ancestor of the class of the kind classified as the mutable entity, based on the parent-child information, and changes a kind of the identified class to the neutral entity. Further, it changes a kind of a descendant class of the class of the kind classified as the mutable entity to the mutable entity, based on the parent-child information. Then, it identifies a class whose kind is not the mutable entity and which is an ancestor of the class of the kind classified as the neutral entity, based on the parent-child information, and changes a kind of the identified class to the neutral entity.

After these processings, it extracts a class which is classified to still be unclassified from all the classes, changes a kind of the extracted class to the immutable entity, and outputs information about the class classified as the immutable entity, as immutable entity extraction information.

As described above, in the present embodiment, the neutral entity is set as a kind in addition to the immutable entity and the mutable entity, so that a class which is the mutable entity can be extracted correctly.

Further, a set of classes having a circular reference structure, which is often classified as the mutable entity in the conventional method, can also be extracted as the immutable entity.

The program according to the present embodiment is further intended to cause the computer to execute: 9) immutable entity designation information input processing for accepting immutable entity designation information which indicates a class to be classified as the immutable entity, as input; and 10) invalid immutable entity output processing for, if a class designated by the immutable entity designation information as immutable entity is the class whose kind is changed to the mutable entity or the neutral entity in any of the first classification change processing, the second classification change processing, the third classification change processing, and the fourth classification change processing, outputting the relevant class as an invalid immutable entity.

If needed, the immutable entity may be designated manually. Generally, whether a class is the immutable entity or not depends on whether another class referenced by the class is the immutable entity or not. Therefore, if a class which is the immutable entity is designated by an initial or starting point condition, more number of immutable entities can be extracted based on this designation.

Further, when after immutable entity extraction processing manual or input designation of immutable entity causes conflict, information about a conflicting class can be outputted as the invalid immutable entity.

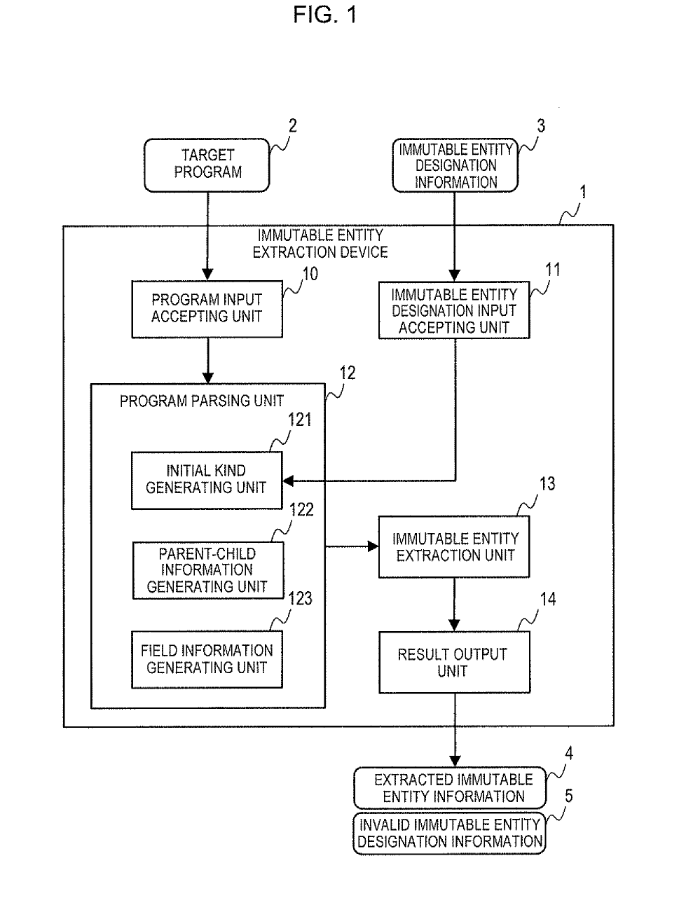

FIG. 1 shows a configuration example of one embodiment. An immutable entity extraction device 1 according to the present embodiment is configured to receive as input a target program 2 and immutable entity designation information 3, and output extracted immutable entity information 4 or invalid immutable entity designation information 5. The target program 2 is source code of any object-oriented program which can be ready to execute and which is a target to be processed in which the immutable entity is extracted.

In the present embodiment, the target program 2 is a JAVA program, and can load all of classes that can be used by the program, in which a parent-child relationship of each class and a field of each class are statically defined (that is, cannot be changed dynamically), and final constraint (the constraint that assignment is allowed only once) can be imposed on a field.

The immutable entity designation information 3 is information which indicates a class that is inputted as needed and designated as the immutable entity. The extracted immutable entity information 4 is information containing a set of identifiers of classes classified as the immutable entity which is extracted from the target program 2. The invalid immutable entity designation information 5 is information containing an identifier of a class determined as the invalid immutable entity which is determined to be invalid based upon the immutable entity designation information 3.

The immutable entity extraction device 1 is a computer composed of a CPU and a memory, and includes a program input accepting unit 10, an immutable entity designation input accepting unit 11, a program parsing unit 12, an immutable entity extraction unit 13, and a result output unit 14, which can be composed of software programs.

The program input accepting unit 10 is a processing unit which accepts a set of JAVA class files as the target program 2. The immutable entity designation input accepting unit 11 is a processing unit which accepts the immutable entity designation information 3 that indicates a class designated as the immutable entity, if needed. The program parsing unit 12 is a processing unit which executes known analysis processing of the target program 2, and includes an initial kind generating unit 121, a parent-child information generating unit 122, and a field information generating unit 123. The program parsing unit 12 is a processing unit which performs known parsing processing on the inputted target program 2 (a set of class files) to generate class information.

The initial kind generating unit 121 is a processing unit which sets “unclassified” as an initial (starting point) classification kind of classes of the target program 2. When the immutable entity designation information 3 is inputted by the immutable entity designation input accepting unit 11, the initial kind of a relevant class is set to “immutable entity” based on the immutable entity designation information 3.

The parent-child information generating unit 122 is a processing unit which makes it possible to use parent-child information which indicates an ancestor class and a descendant class of each class, from the result of analysis processing of the target program 2.

The field information generating unit 123 is a processing unit which makes it possible to use field information from the result of analysis processing of the target program 2. In field information, a constraint on assignment, immutability of an array, and the like are contained.

The immutable entity extraction unit 13 is a processing unit which classifies each class in the target program 2 as the immutable entity or not, based on an initial kind/type of classification, parent-child information, and field information. Further, it determines whether the initial kind of a class is invalid, and if the initial kind is invalid, extracts corresponding invalid entity designation as invalid designation.

The result output unit 14 is a processing unit which outputs the extracted immutable entity information 4 which indicates a class which is the immutable entity that is extracted by the immutable entity extraction unit 13 or the invalid immutable entity designation information 5 which indicates a class designated by invalid immutable entity designation.

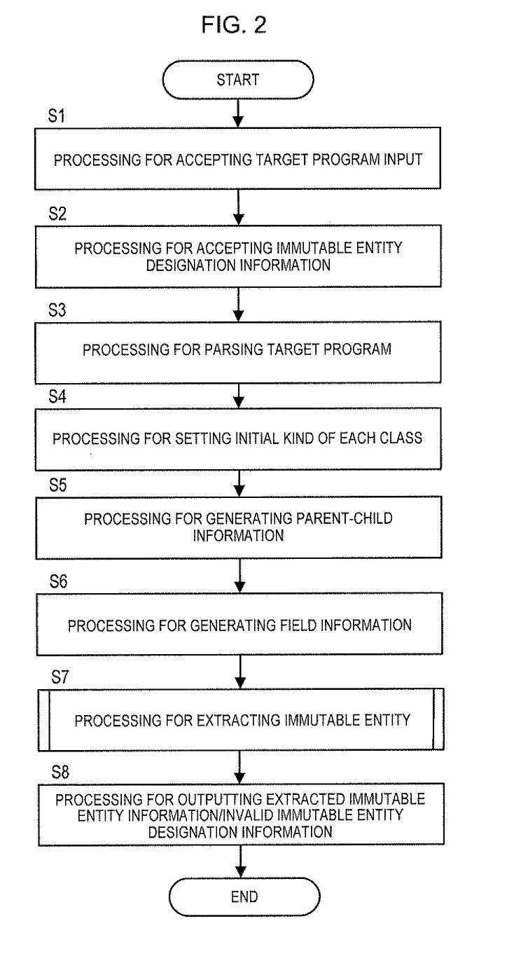

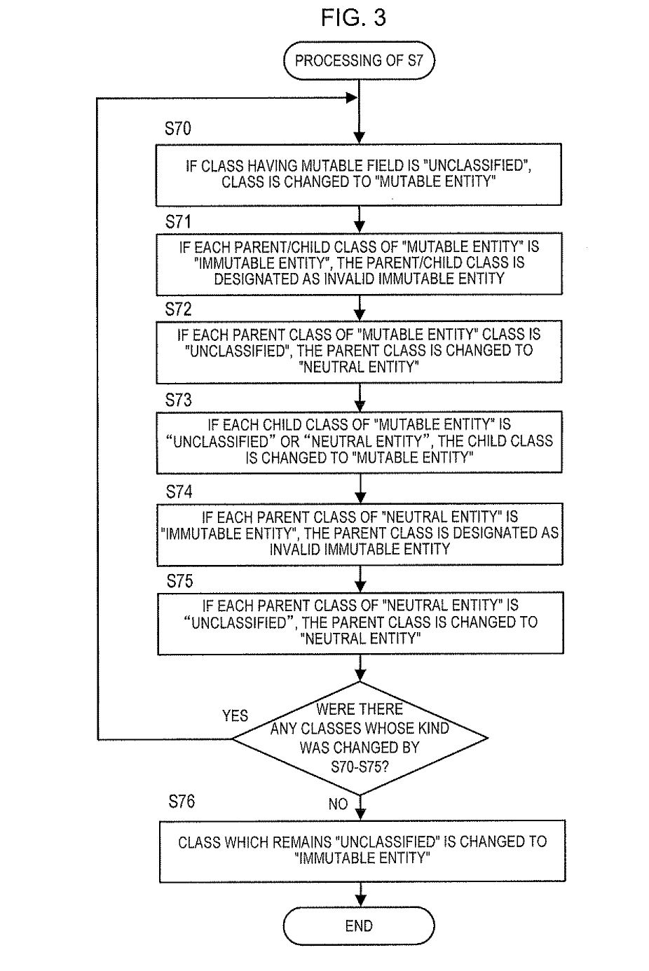

A processing flow of the immutable entity extraction device 1 will be described with reference to FIGS. 2 and 3.

Step S1: The program input accepting unit 10 of the immutable entity extraction device 1 accepts a set of Java® class files as the target program 2.

Step S2: The immutable entity designation input accepting unit 11 accepts a set of fully qualified class names as the immutable entity designation information 3. The fully qualified class name is a name for uniquely identifying a class. Input of the immutable entity designation information 3 is optional, and a null set may be accepted.

Step S3: The program parsing unit 12 generates class information of the target program 2 (the set of class files) using known parsing processing (For example, Jakarta BCEL (Byte Code Engineering Library)).

Step S4: The initial kind generating unit 121 creates a hash table (kind hash table) for all classes of the parsed set of classes of the target program 2. In the hash table, a fully qualified class name is a key and “unclassified” as a classification kind is a value. Further, a value of a class which is defined as an immutable entity in the language specification of the target program 2 is set to “immutable entity”. For example, String in JAVA corresponds to the immutable entity. If the immutable entity designation information 3 is inputted, a value of a class designated by a set of fully qualified class names of the immutable entity designation information 3 is set to “immutable entity”.

Step S5: The parent-child information generating unit 122 generates parent-child information with respect to all classes of the parsed set of classes of the target program 2. Specifically, procedures such as JavaClass.getInterfaces( ) and JavaClass.getSuperClass( ) of BCEL are used. The parent information and child information are created for each pair of classes in a parent-child relationship.

The parent information is a hash table (parent information hash table) in which a fully qualified class name of a class is a key and a fully qualified class name of a parent class of the class is a value. The child information is a hash table (child information hash table) in which a fully qualified class name of a class is a key and a fully qualified class name of a child class of the class is a value.

Step S6: The filed information generating unit 123 generates field information with respect to all classes of the parsed set of classes of the target program 2. The field information is a hash table (field hash table) in which a fully qualified class name is a key and unit field information is a value.

The unit field information is a set of a fully qualified class name which is a type of a field and a logical value which indicates whether the field is “obviously mutable”. The unit field information is represented as a hash table in which a fully qualified class name is a key and a logical value indicating whether the field is “obviously mutable” is a value. In this case, if there is no final constraint, “obviously mutable” is applied. In addition, if the field type is an array type, “obviously mutable” is applied. On the other hand, since a basic type field having a final constraint is immutable, it is not registered with the field information.

Step S7: The immutable entity extraction unit 13 extracts a class classified as “immutable entity” from among classes in the target program 2. Further, it determines whether the kind of a class is invalid based upon the immutable entity designation information 3, and if the kind is invalid, extracts corresponding invalid immutable entity designation.

FIG. 3 is a flow chart of the S7 operation, at which the immutable entity extraction unit 13 determines a kind of each class of the target program 2 in the following procedure.

Step S70: If the kind of a class having a mutable field is “unclassified”, the kind is changed to “mutable entity”.

Step 71: In the processing of step S71, if the kind of a parent or child class of a class whose kind is “mutable entity” is “immutable entity”, the parent or child class is designated as the invalid immutable entity.

Step S72: If the kind of a parent class of a class whose kind is “mutable entity” is “unclassified”, the kind of the parent class is changed to “neutral entity”.

Step S73: The kind of a child class of a class whose kind is “unclassified” or “neutral entity” is changed to “mutable entity”.

Step S74: If the kind of a parent class of a class whose kind is “neutral entity” in the processing of steps S72, S73 is “immutable entity”, the parent class is designated as the invalid immutable entity.

Step S75: If the kind of an parent class of a class whose kind is “neutral entity” is “unclassified”, the kind of the parent class is changed to “neutral entity”.

While there were some classes whose kind was changed by steps S70 to S75, these steps are processed again.

Step S76: After the processing of steps S70 to S75, the kind of a class whose kind is “unclassified” is changed to “immutable entity”.

Step S8: The result output unit 14 outputs the extracted immutable entity information 4 which indicates a set of fully qualified class names of classes whose kind is “immutable entity”. In addition, it outputs the invalid immutable entity designation information 5 which indicates a set of fully qualified class names of classes corresponding to invalid immutable entity designation.

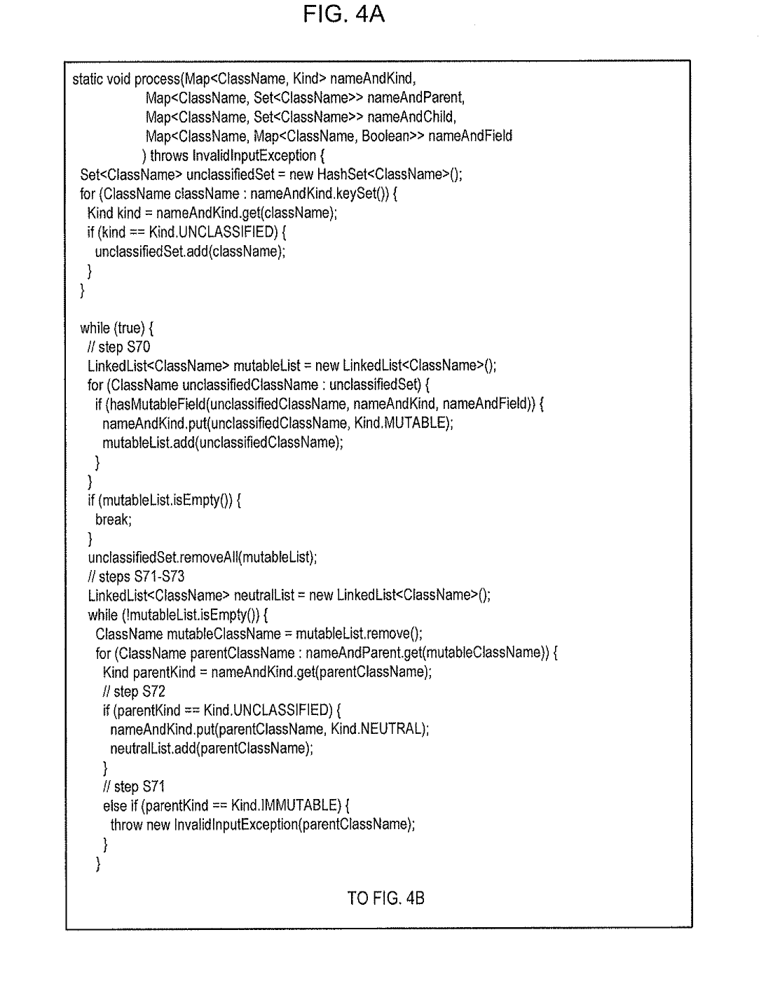

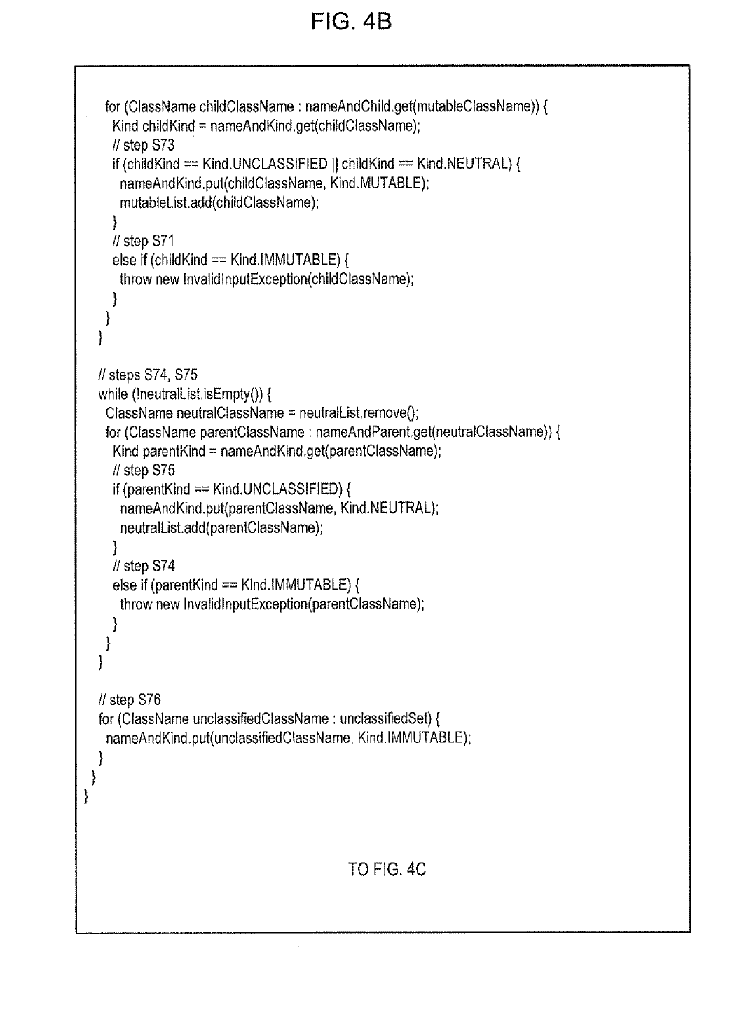

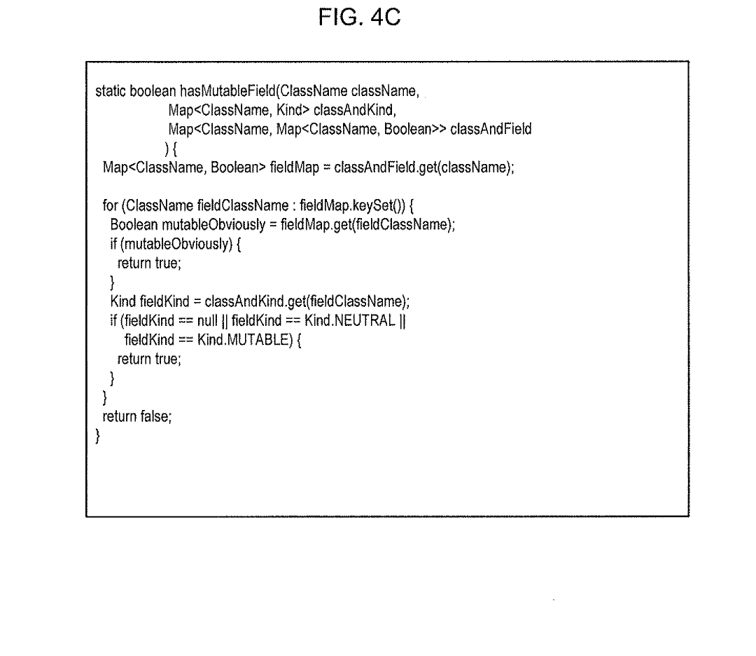

FIGS. 4A to 4C are diagrams showing an example of pseudo code which implements the immutable entity extraction unit 13. FIGS. 4A to 4C are one pseudo code which represents the immutable entity extraction unit 13, in which numbers of “step” generally corresponds to the above described steps S70 to S76.

In the processing of the first line of the pseudo code in FIG. 4A, “Map” is java.util.Map and corresponds to a hash table. The arguments correspond to initial kind (kind), parent information, child information, and field information respectively in order.

“Set” is java.util.Set and “HashSet” is java.util.HashSet, corresponding to a hash table having no value.

“LinkedList” is java.util.LinkedList, corresponding to a data structure queue (FIFO).

The 12th line to 14th line of the pseudo code in FIG. 4C represents “a class having a field where field information is null has a mutable field”. Thereby, the target program 2 in which a link to a field is not always allowed can also be handled as input. In other words, when the target program 2 which contains a class having a field without code of a type (class) is accepted as input, such a class is processed as a class having a mutable field.

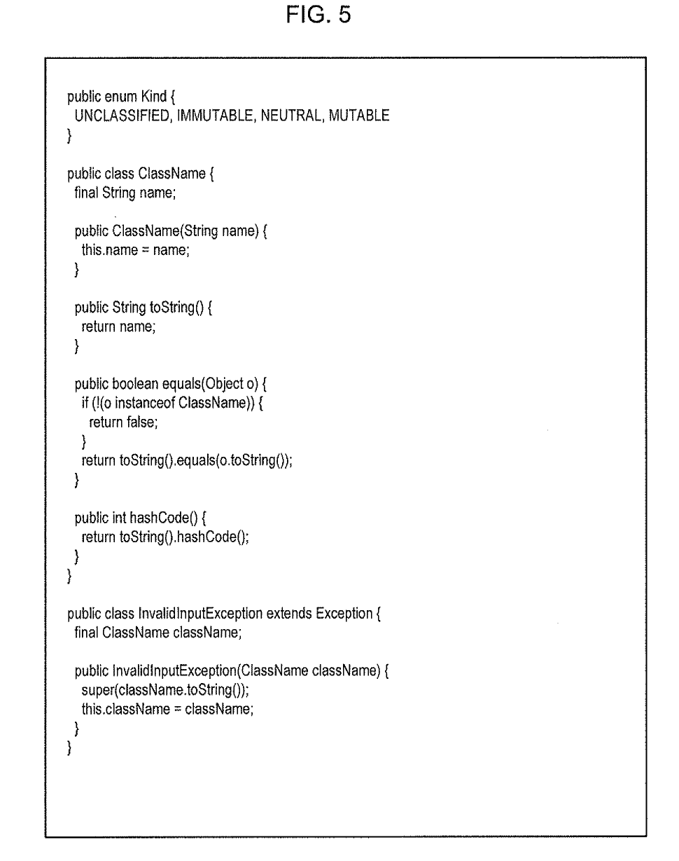

FIG. 5 is a diagram showing a code example of a kind of class (Kind), a class name (ClassName), and invalid immutable entity designation (InvalidInputException) which are used by the immutable entity extraction unit 13 in FIGS. 4A to 4C. In other words, FIG. 5 specifies kinds of classes. A class Kind, which indicates a kind of class, is an enumerated type to indicate any one of four values: unclassified, immutable entity, neutral entity, and mutable entity.

A class ClassName, which represents a fully qualified class name, is a type for retaining a string (String). A class InvalidInputException, which represents the invalid immutable entity designation information 5, is a type for retaining ClassName designated as invalid immutable entity.

According to an aspect of an embodiment, an unclassified, an immutable entity, a mutable entity, and a neutral entity as kinds of classes are provided. Then all of the classes of a parsed object-oriented program are initially classified as unclassified, and the classifications are changed based on at least a field information and at least parent-child information. Any class that remains unclassified after the classification changes is changed to an immutable entity. Information is output about the classes classified as the immutable entity as immutable entity extraction information.

A program for causing a computer to function as the immutable entity extraction device 1 to execute the above described processing, can be stored in any suitable computer-readable recording medium such as a portable memory, a semiconductor memory, or a hard disk. Then, the program may be provided as such a recording medium having the program recorded thereon, or may be provided by transmission and reception using various communication networks through a communication interface.

Therefore, according to an aspect of the embodiments of the invention, any combinations of the described features, functions, operations, and/or benefits can be provided. The embodiments can be implemented as an apparatus (a machine) that includes computing hardware (computing apparatus), such as (in a non-limiting example) any computer that can store, retrieve, process and/or output data and/or communicate (network) with other computers. According to an aspect of an embodiment, the described features, functions, operations, and/or benefits can be implemented in computing hardware and/or software. The apparatus (e.g., the immutable entity extraction device 1, etc.) comprises a controller (CPU) (e.g., a hardware logic circuitry based computer processor that processes or executes instructions, namely software), computer readable recording media, transmission communication media interface (network interface), and/or a display device, all in communication through a data communication bus. The results produced can be displayed on a display of the computing hardware. A program/software implementing the embodiments may be recorded on computer readable media comprising computer-readable recording media. The program/software implementing the embodiments may also be included/encoded and transmitted over transmission communication media.

Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. Examples of transmission communication media include a carrier-wave signal, an optical signal, etc.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable recording medium on which a processing program for extracting an immutable entity of a program is recorded, the processing program causing a computer to execute:
accepting as input an object-oriented program;
parsing the input object-oriented program, and acquiring parent-child information between classes and field information with respect to all classes of the object-oriented program;
providing an unclassified, an immutable entity, a mutable entity, and a neutral entity as kinds of classes, and classifying all of the classes of the parsed object-oriented program as the unclassified kind;
first classification change processing for determining whether the class classified as the unclassified has a mutable field based on the field information, and, if the class classified as the unclassified has the mutable field, changing a kind of the class to the mutable entity;
second classification change processing for identifying a class whose kind is unclassified and which is an ancestor of the class whose kind is classified as the mutable entity, based on the parent-child information, and changing a kind of the identified class to the neutral entity;
third classification change processing for changing a kind of a descendant class of the class whose kind is classified as the mutable entity to the mutable entity, based on the parent-child information;
fourth classification change processing for identifying a class whose kind is unclassified and which is an ancestor of the class whose kind is classified as the neutral entity, based on the parent-child information, and changing a kind of the identified class to the neutral entity;
extracting a class remaining as the unclassified after some executions of the first classification change processing, the second classification change processing, the third classification change processing, and the fourth classification change processing, and changing a kind of the extracted remaining class to the immutable entity; and
outputting information about the classes classified as the immutable entity as immutable entity extraction information.

2. The computer-readable recording medium according to claim 1, the processing program further causing the computer to execute:
accepting immutable entity designation information which indicates a class to be classified as the immutable entity; and
outputting a class as an invalid immutable entity, if a class designated by the immutable entity designation information as the immutable entity is the class whose kind is changed to the mutable entity or the neutral entity in any of the first classification change processing, the second classification change processing, the third classification change processing, and the fourth classification change processing.

3. A processing device for extracting an immutable entity of a program, the processing device comprising:
a processor executing
accepting as input an object-oriented program to be processed;
parsing the input object-oriented program, and acquires parent-child information between classes and field information with respect to all classes of the object-oriented program;
providing an unclassified, an immutable entity, a mutable entity, and a neutral entity as kinds of classes, and classifying all of the classes of the parsed object-oriented program as the unclassified kind;
a first classification changing by determining whether the class classified as the unclassified has a mutable field based on the field information, and, if the class classified as the unclassified has the mutable field, changing a kind of the class to the mutable entity;
a second classification changing by identifying a class whose kind is unclassified and which is an ancestor of the class whose kind is classified as the mutable entity, based on the parent-child information, and changing a kind of the identified class to the neutral entity;
a third classification changing by changing a kind of a descendant class of the class whose kind is classified as the mutable entity to the mutable entity, based on the parent-child information;
a fourth classification changing by identifying a class whose kind is unclassified and which is an ancestor of the class whose kind is classified as the neutral entity, based on the parent-child information, and changing a kind of the identified class to the neutral entity;
extracting a class remaining as the unclassified after some executions of the first classification changing, the second classification changing, the third classification changing, and the fourth classification changing, and changing a kind of the extracted remaining class to the immutable entity; and
outputting information about the classes classified as the immutable entity as immutable entity extraction information.

4. A method of extracting an immutable entity of a program, comprising:
using a processor to execute processes of
accepting as input an object-oriented program;
parsing the input object-oriented program, and acquiring parent-child information between classes and field information with respect to all classes of the object-oriented program;
providing an unclassified, an immutable entity, a mutable entity, and a neutral entity as kinds of classes, and classifying all of the classes of the parsed object-oriented program as the unclassified kind;
determining whether the class classified as the unclassified has a mutable field based on the field information, and, if the class classified as the unclassified has the mutable field, changing a kind of the class to the mutable entity;
identifying a class whose kind is not the mutable entity and which is an ancestor of the class whose kind is classified as the mutable entity, based on the parent-child information, and changing a kind of the identified class to the neutral entity;
changing a kind of a descendant class of the class whose kind is classified as the mutable entity to the mutable entity, based on the parent-child information;
identifying a class whose kind is not the mutable entity and which is an ancestor of the class whose kind is classified as the neutral entity, based on the parent-child information, and changing a kind of the identified class to the neutral entity;
extracting any class remaining as the unclassified after the class changes, and changing a kind of the extracted remaining class to the immutable entity; and
outputting information about the classes classified as the immutable entity as immutable entity extraction information.
